(19) United States
(12) Patent Application Publication
(10) Pub. No.: US 2005/0176586 A1
(43) Pub. Date: Aug. 11, 2005

(54) High-field superconductors

(76) Inventors: Damian P. Hampshire, Durham (GB); Niu Hoogiun, Durham (GB)

Correspondence Address: Pepper Hamilton;Firm 21269, One Mellon Center 50th Floor, 500 Grant Street, Pittsburgh, PA, 15219, US

(21) Appl. No.: 10/513,271

(22) PCT Filed: May 2, 2003
(86) PCT No.: PCT/GB03/01920

(30) Foreign Application Priority Data
May 2, 2002 (GB) 0210041.0

(51) Int. Cl. H01B 1/00

(52) U.S. Cl. 505/100

(57) ABSTRACT

A method of increasing the upper critical field of a crystalline superconducting material is provided, which comprises the steps of converting the crystalline superconducting material to a substantially amorphous state, and then re compacting and crystallising the material. The method also has the effect of increasing the critical current density of the material, and is effective with both brittle and ductile superconductors.

The present invention concerns methods for the manufacture of superconductor materials. More particularly, the invention concerns methods of increasing the upper critical field value (“B_{C2}”) of crystalline superconductor materials to produce high-field superconductor materials, e.g. for use in superconducting electromagnets, or in power transmission applications.

In relation to superconductor materials, the upper critical field (B_{C2}) is the magnetic field strength (Tesla, T) that delineates the superconducting phase from the non-superconducting (or normal) phase. Clearly a material cannot be used in magnetic fields above B_{C2} in superconducting applications. The critical current density (J_{C}) is the maximum useful current density a superconductor can carry. J_{C} depends on the magnetic field the superconductor is exposed to. As a ball-park figure, when J_{C} drops below about 4×10⁴ A.cm⁻², the size of the magnet starts to increase and costs start to increase rapidly.

High magnetic fields play an important role in modern technological society. There are essentially three areas of activity:
A) Magnetic Fields of up to ˜12 Tesla: Medical body scanners, particle accelerators, ore separators, low field research magnets, maglev trains.
   The most important superconducting material used in this field range is a ductile NbTi alloy. A number of other ductile superconducting materials have been investigated in the past but ease of fabrication and an upper critical field of about 10-12 T makes it the material of choice.
   Note that even in magnets with a peak field above 12 T, the low field parts use NbTi windings because of the material's ductility.
   The ductility of NbTi is critical, since it directly translates into reliability and ease of use. However its upper critical field is about ˜12 T so clearly is useless for producing high magnetic fields above 12 T.
   There are no known ductile superconductors that can operate in magnetic fields significantly above say 12 T.
B) Magnetic Fields of 12-22 Tesla.
   Because there are no ductile superconductors that can operate in this field range, brittle superconductors have to be used, such as Nb₃Sn.
   Multi-million pound demonstrators have been built but handling brittle materials remains problematic and the commercial market is commensurately smaller.
   Nevertheless there is still a significant market in the range 12 T to 22 T including all high field Research laboratory magnets and all n.m.r systems (operating above 426 Mhz˜10 Tesla). There is also an application in Fusion Tokamaks (currently designed to operate at 13.7 Tesla). It should be noted that there is an enormous premium in increasing the field at which Tokamaks operate—which is currently set by the current carrying capacity and the reliable use of brittle superconductors.
   There are other brittle materials that compete with Nb₃Sn, namely Nb₃Al and MgB₂ and ternary and quaternary compounds of these binaries as well as the developmental compounds.
C) Magnetic Fields above 23 Tesla
   There are no superconducting magnets operating in fields significantly above 22 T. Above 22 Tesla, the commercial materials of choice approach their upper critical field and are no longer useful.
   There is an enormous effort directed at trying to improve the properties of developmental superconductors for making magnets that can operate above 22 T, and for power transmission applications. This includes:
      Chevrel phase superconductors which have very high B_{C2} values of 60 T but do not have sufficiently high J_{C}. J_{C} would need to be increased up to about 4×10⁴ A.cm⁻² at operating fields above 22 T for these materials to be useful.
      Quaternary Nb₃Al which has higher B_{C2} than binary Nb₃Al and very encouraging high J_{C} values. The problem appears to be that the manufacturing of these materials is complex and currently unreliable in producing long lengths of wire.
      Improving Nb₃Sn. There are many techniques that have been developed to fabricate Nb₃Sn.
      Development of High temperature superconductors (e.g. Y₁Ba₂Cu₃O₇, Bi₂Sr₂CaₙCuₙ₊₁O₆₊₂ₙ, Tl₂Ba₂CaₙCuₙ₊₁O₆₊₂ₙ, and HgBa₂CaₙCuₙ₊₁O₂ₙ₊₄ compounds where n is an integer). These materials are particularly useful for both high-field and power transmission applications.

Prior efforts to increase B_{C2} have concentrated on doping high field superconductors. Many of the improvements are explained using:
B_{C2}(0)=3.1×10³γρ_{N}T_{C}
where γ is the Sommerfeld constant, ρ_{N} is the normal state resistivity and T_{c} is the critical temperature. So by doping the material and increasing the resistivity, B_{C2} is increased.

The present invention provides a method of increasing the upper critical field of a crystalline superconducting material, comprising the steps of:
converting the crystalline superconducting material to a substantially amorphous state; and
re-compacting the material.

It will be appreciated that a “crystalline superconducting material” as referred to here includes material that is only crystalline in part.

Preferably, the method further comprises the step of crystallising the material.

Generally, the step of crystallising the substantially amorphous material comprises nanocrystallisation of the material.

The method may also have the effect of increasing the critical current density (J_{C}) of the material.

The superconductor may be converted to a substantially amorphous state by any means that pumps energy into the material to increase its energy state from a low level (crystalline) to a high level (amorphous). This is most preferably done by mechanical attrition (such as ball-milling), but other equivalent methods may be used.

The substantially amorphous material may be re-compacted and crystallised by means of heat and/or pressure, most preferably by thermomechanical processing (such as hot isostatic pressing (HIP) and/or annealing).

The resultant material has a small grain size with a high defect density, thereby increasing the resistivity and thus B_{C2} as compared with the original crystalline material. The grains themselves may also have a high defect density. These properties may also have the effect of increasing J_{C} as compared with the original material.

Existing high-field superconductors operating in magnetic fields above 12 T tend to be brittle materials. The application of the present invention to such materials provides materials with increased B_{C2} and/or J_{C}, enabling new and/or improved applications of such materials. Existing ductile superconductors tend to have relatively low B_{C2}, unsuitable for high-field applications above 12 T. The application of the present invention to such materials may provide ductile materials suitable for higher-field applications.

For example, the invention may be applied to improve B_{C2} in existing commercial 12-22 T field superconductor materials, such as Nb₃Sn. The invention may also be applied to improve B_{C2} in existing commercial <12 T field superconductor materials such as NbTi (including doped NbTi), extending the use of such materials to higher fields. It may also be applied to elemental superconductors such as Nb and Pb, or alloys of these metals, where T_{C} is sufficiently high for applications but B_{C2} is far to low. For example body scanners could operate at higher fields with higher resolution; all low field sections of high field (12 T-22 T) large scale systems could use such improved materials.

The invention may also be applied to superconductor materials that are currently only of interest as research materials, such as Chevrel phase materials, potentially improving the properties of such materials to the extent that they become commercially useful.

The invention has been used to increase B_{C2} in a Chevrel phase compound from 60 T up to 120 T by using ball-milling followed by HIP/annealing.

It will be understood that B_{C2} is temperature dependent and that, as is conventional in the art, values of B_{C2} quoted herein are extrapolated values for B_{C2} at zero Kelvin (“B_{C2} (0)”).

The invention has also been applied to increase J_{C} in a Chevrel phase compound (PbMo₆S₈, “PMS”) at zero field by about a factor of 2 and to increase J_{C} in high fields by at least a factor of 3. The invention may also increase J_{C} in other materials by a similar factor.

The resistivity of the superconductor material increases markedly after ball-milling and compaction and then decreases following HIP'ing/annealing. The resistivity is strongly correlated with an increase in B_{C2} (and kappa—the Ginzburg-Landau constant, κ). See Table 1, below which shows how the resistivity increases from 80 μΩ.cm (B_{C2}˜47 T) without any milling up to 676 μΩ.cm (B_{C2}˜139 T) by ball-milling and back down again 485 μΩ.cm (B_{C2}˜107 T) to 363 μΩ.cm (B_{C2}˜66 T) with differing heat treatments.

TABLE 1
Superconducting parameters obtained from
reversible magnetisation of PbMo₆S₈ samples

| | T_{C} | B_{C2}(0) | | ρ_{N} (16 K) |
|---|---|---|---|---|
| Sample | (K) | (T) | κ | (μΩcm) |
| No. 1 | 14.42 | 46.65 | 124 | 80 |
| No. 2 | 11.87 | 139.48 | 586 | 676 |
| No. 3 | 12.36 | 106.77 | 402 | 485 |
| No. 4 | 12.86 | 66.11 | 243 | 363 |

Processing condition:
No. 1: PMS, milling time: 0 h, HIP 800° C. × 8 h.
No. 2: PMS, milling time: 200 h, HIP 800° C. × 8.
No. 3: PMS, milling time: 200 h, HIP 800° C. × 8 h, annealing: 800° C. × 40 h.
No. 4: PMS, milling time: 200 h, HIP 600° C. × 8 h, anneal: 600° C. × 40 h, 1000° C. × 40 h

As noted above, the invention uses ball-milling (or an equivalent process) to produce substantially amorphous superconducting material. The material is then recompacted and crystallised to produce very small grain size material which probably has many scattering centres and pinning defects inside the grains. The small grain size and high defect concentration results in high resistivity with high upper critical field, B_{C2}.

It has been long known that in low magnetic fields the critical current density, J_{C}, increases when the grain size is decreased. The use of ball-milling to produce amorphous material which can then be crystallised into material with very small grain-size also increases J_{C} markedly.

Chevrel phase superconductors and Nb₃Sn have both been used as powders to produce wires. High temperature superconductors are also produced routinely using powder metallurgy. Techniques such as ball-milling may be used to thoroughly mix the powders, however, this type of mixing is very different from the present use of ball-milling for producing amorphous material and crystallising.

It will be understood that suitable or optimal parameters for ball-milling, HIP and/or annealing (or equivalents) for the purposes of the present invention may be determined empirically for particular materials. The basic principle for the crystallisation method is to control the crystallisation kinetics of amorphous solids by optimising the heat treatment conditions (for example, annealing temperature, time and heating rate) so that the amorphous phase crystallises into a polycrystalline material with ultrafine crystallites; i.e. to ensure that the nucleation rate is high while the growth rate is small.

As used herein, “substantially amorphous” means amorphous or nanocrystalline or a mixture thereof. Also as used herein, references to crystallising the substantially amorphous material means returning amorphous material to a crystalline state and “re-crystallising” any nanocrystalline components of the “substantially amorphous material”. It will be understood that “re-crystallisation”, when used in its strict technical sense, generally means changing a material with small crystals or strained crystals into a material with larger crystals. “Crystallised” is often used to describe changing an amorphous material into a crystalline material. The method of the present invention predominantly involves “crystallising” amorphous material, but since the material may not be completely amorphous some limited “re-crystallisation” may also take place.

Nanocrystalline (NC) materials are characterized structurally by the ultrafine grains and the numerous grain boundaries. The grain boundaries of NC materials may be different from those of conventional coarse grain, such as equiaxed grain morphology, low-energy grain boundary structure and flat grain boundary configuration. This produces unusual physical, chemical and mechanical properties with respect to the conventional coarse grained materials. Ball-milling is one of the most effective routes to fabricate NC materials of metals and alloys. High-energy impact during ball milling introduces severe plastic deformation of the milled powder and forms nanocrystalline or amorphous powder. Nanocrystallisation of the amorphous powder results in formation of NC materials which usually have dense and clean grain boundaries, low microstrain and nearly perfect crystallite structure.

By way of an example of the present invention, nanocrystalline and amorphous PbMo₆S₈ (PMS) powder was fabricated using ball-milling. The ball-milled PMS powder was then subsequently hot isostatic pressed (HIP'ed) and (in some cases) annealed to obtain bulk samples.

Sintered PMS powder (5 g) with 6 Syalon balls with a diameter of 20 mm was put into the Syalon pot and ball-milled for 200 h at a rotational velocity of 300 revolutions per minute (rpm). The weight ratio of ball to powder was ˜16:1. Ball milling was carried out in a steel box under Ar gas flow. The milled powder was wrapped with Mo foil and stainless steel and then HIP'ed at a pressure of 2000 bar and temperatures of 600, 800° C. for 8 h. Some of the HIP'ed samples were subsequently annealed at temperatures of 600, 800 and 1000° C. for 40 h. The details of the processing conditions are listed in Table 1 above.

The milled powder has a relatively regular and equiaxed morphology. The particle sizes are in the range of 50-300 nm for the powder milled for 200 h. A preliminary TEM study reveals that the milled particles consist of amorphous and nanocrystalline phase with grain sizes of 10-20 nm.

As a second example, the invention has also been used to increase B_{C2} at 2 K in Nb from 1.3 T up to 3.9 T by using ball-milling followed by pressing at room temperature.

B_{C2} is temperature dependent and measurements quoted for Nb are extrapolated values for B_{C2} at 2 K.

TABLE 2
Superconducting parameters obtained from
irreversible magnetisation of Nb samples

| | T_{C} | B_{C2}(2 K) |
|---|---|---|
| Sample | (K) | (T) |
| 1 | 8.6 | 1.3 |
| 2 | 7.9 | 3.9 |

Processing condition:
No. 1: Nb, milling time: 0 h, Uniaxially pressed 20° C. × 10 mins.
No. 2: Nb, milling time: 10 h, Uniaxially pressed 20° C. × 10 mins.

The step of re-compacting the amorphous/nanocrystalline material is achieved by pressing the Nb at room temperature. The produced pressed powder exhibits the physical properties of a significantly increased upper critical field and critical current density. As the process is carried out at room temperature, that is, no special heat treatments are applied, there is no crystallisation involved. However, any form of heat treatment could be additionally applied, which may result in a bulk material being produced that exhibits an even larger increase in B_{C2} and J_{C}.

Improvements and modifications may be incorporated without departing from the scope of the invention.

1. A method of increasing an upper critical field of a crystalline superconducting material, comprising the steps of:
converting the crystalline superconducting material to a substantially amorphous state material; and
re-compacting the substantially amorphous state material.

2. The method of claim 1, further comprising the step of crystallizing the substantially amorphous state material.

3. The method of claim 1, wherein a critical current density (J_{C}) of the crystalline superconducting material is increased.

4. The method of claim 2, wherein the step of crystallizing the substantially amorphous state material comprises nanocrystallization of the material.

5. The method of claim 1, wherein the step of converting the crystalline superconducting material to the substantially amorphous state material comprises pumping energy into the material to increase its energy state from a low level crystalline state to a high level amorphous state.

6. The method of claim 5, wherein the increase in energy state further comprises a mechanical attrition step.

7. The method of claim 6, wherein the mechanical attrition step comprises ball-milling.

8. The method of claim 1, wherein the step of re-compacting the substantially amorphous state material further comprises the step of applying at least one of heat or pressure.

9. The method of claim 2, wherein the step of crystallizing the substantially amorphous state material further comprises the step of applying at least one of heat or pressure.

10. The method of claim 8, wherein the step of applying at least one of heat or pressure comprises thermomechanical processing.

11. The method of claim 10, wherein the thermomechanical processing comprises at least one of hot isostatic pressing (HIP) or annealing.

12. The method of claim 1, wherein the crystalline superconducting material is a brittle superconductor.

13. The method of claim 12, wherein the brittle superconductor is Nb₃Sn.

14. The method of claim 1, wherein the crystalline superconducting material is a ductile superconductor.

15. The method of claim 14, wherein the ductile superconductor is doped NbTi.

16. The method of claim 1, wherein the crystalline superconducting material is an elemental superconductor or an alloy thereof.

17. The method of claim 2, wherein the step of crystallizing the substantially amorphous state material further comprises controlling the crystallization kinetics of an amorphous solid by optimizing heat treatment conditions for the amorphous phase to crystallize into a polycrystalline material with ultrafine crystallites.

18. The method of claim 17, wherein a crystallite nucleation rate is high and a crystallite growth rate is small.

19. The method of any of claim 5, wherein the step of re-compacting the substantially amorphous state material further comprises applying at least one of heat or pressure, wherein parameters for applying at least one of heat or pressure and pumping energy into the substantially amorphous state material are selected for the crystalline superconducting material to which the method is to be applied.

20. A crystalline superconducting material treated according to the method of claim 1.

21. A crystalline superconducting material as claimed in claim 19, having very small grain size, with many scattering centers and pinning defects inside the grains.

22. The method of claim 9, wherein the step of applying at least one of heat or pressure comprises thermomechanical processing.

23. The method of claim 5, further comprising the step of crystallizing the substantially amorphous state material by applying at least one of heat or pressure, wherein parameters for applying at least one of heat or pressure and pumping energy into the substantially amorphous state material are selected for the crystalline superconducting material to which the method is to be applied.
